(19) United States
(12) Patent Application Publication
(10) Pub. No.: US 2008/0198525 A1
(43) Pub. Date: Aug. 21, 2008

(54) Method for Current Protection of a Power Switch and Apparatus for Implementing Same

(75) Inventor: Hendrikus J. Janssen, Huissen (NL)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 11/914,661

(22) PCT Filed: May 22, 2006
(86) PCT No.: PCT/IB2006/051635

§ 371 Date: Apr. 16, 2008

(30) Foreign Application Priority Data
May 26, 2005 (EP) 05104520.1

(51) Int. Cl. H02H 3/08

(52) U.S. Cl. 361/93.1

(57) ABSTRACT

A method for operating protection circuitry for a power switch (1) uses first and second timing windows which are started in response to the power switch (1) being turned on. The second timing window is greater than the first timing window. During the first timing window, the method prevents operation of first protection circuitry (8) and during the second timing window the method prevent operation of second protection circuitry (10). At the end of the first timing window, but before the end of the second timing window, the method allows operation of the first protection circuitry (8), and at the end of the second timing window, the method allows operation of the second protection circuitry (10) whilst preferably preventing operation of the first protection circuitry (8). In an embodiment, the first protection circuitry (8) provides latched short winding protection for the power switch (1), and the second protection circuitry provides non-latched over current protection for the power switch (1). Apparatus for implementing the method generates blanking signals which control the operation of the first and second protection circuitry.

The present invention relates to a method for current protection of a power switch, which may be implemented, for example, in a Switch Mode Power Supply (SMPS) and other types of power converters in which a current level is measured and needs to be protected.

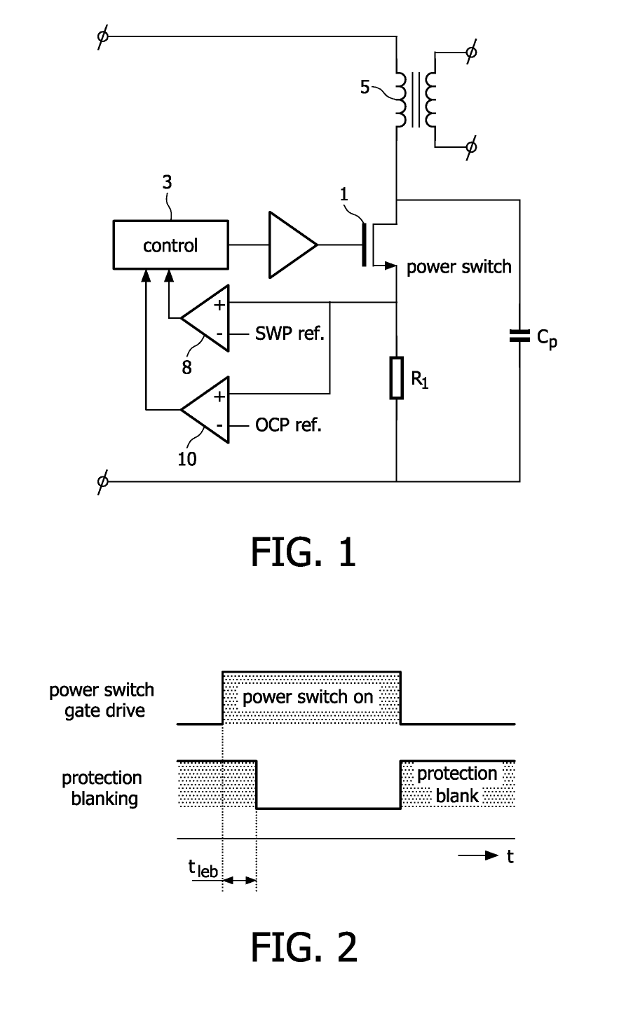

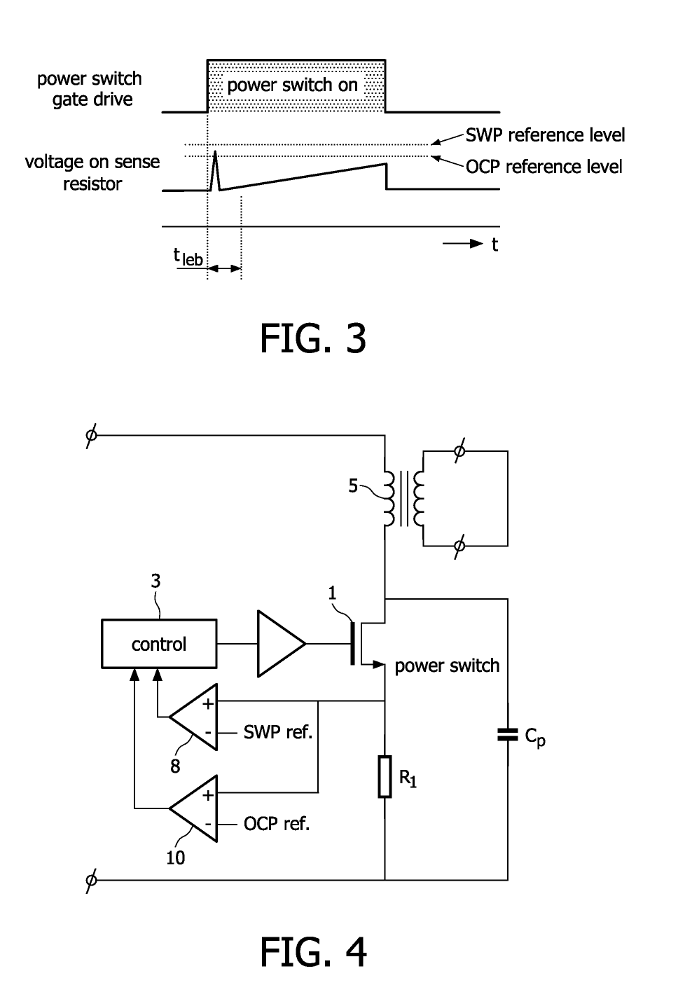

Conventionally, current protection circuitry is used in conjunction with power switches in order to turn off the power switch when high current signals are detected. FIG. 1 illustrates a conventional power protection arrangement and FIGS. 2 and 3 illustrate associated blanking and timing signals respectively. Typically, two different protection current/voltage reference levels are used for latched protection and cycle-by-cycle (non-latched) protection as illustrated in FIG. 3. When a lower level is passed, the power switch is turned off by protection usually called Over Current Protection (OCP). Since OCP protection is non-latched, the power switch will be turned on again in the next switching cycle. When a higher level is passed, the power switch will also be turned off but by different protection usually called Short Winding Protection (SWP). Since SWP protection is latched, the power switch will remain off until a control circuit is reset.

To avoid false triggering of the protection, which may arise when the power switch is turned on due to discharge current peaks arising from parasitic capacitance, a time window called “leading edge blanking window” (t_{leb}) is used immediately upon turn on of the power switch. During the time window t_{leb} the protection is prevented from triggering or “blanked” by a blanking signal as shown in FIG. 2.

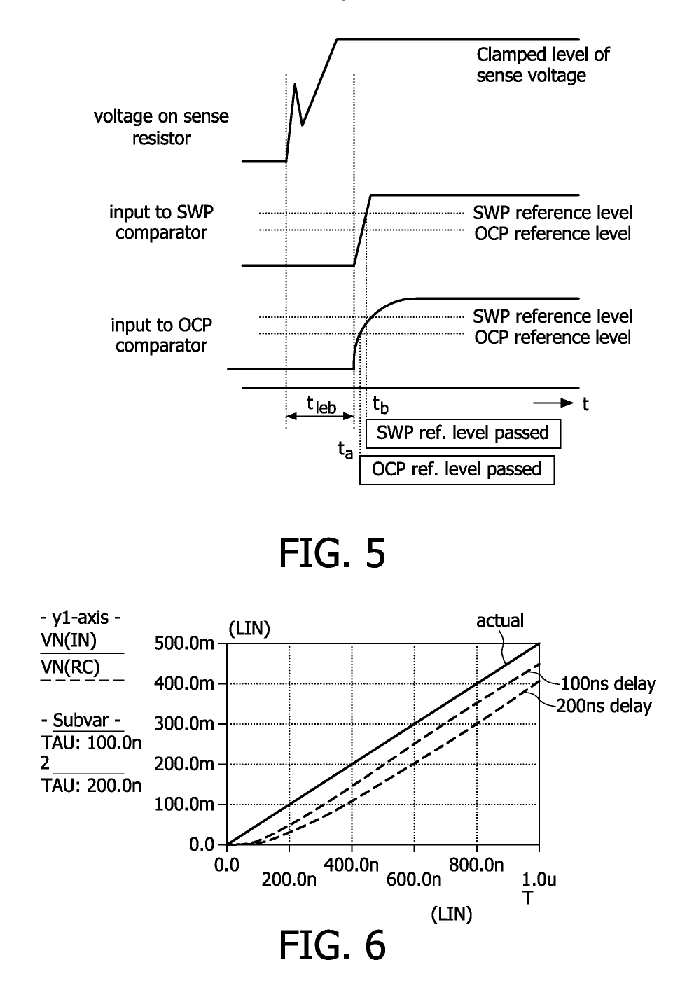

Conventionally, and as mentioned above, the reference level for SWP is higher than the corresponding reference level for OCP to discriminate between the two types of protection. As explained below, for a proper functioning of the protection, the input signal to the OCP comparator needs to have some delay, to ensure that the SWP protection will be triggered first, if the higher SWP reference level is exceeded. For example, the SWP reference level may be exceeded when a fault condition arises, such as a shorted transformer winding as shown in FIG. 4, resulting in leaking inductance as load for the power switch. This leads to a very steep rising current through the switch. FIG. 5 illustrates the relevant signals, which arise in this situation using the conventional methodology. As illustrated in FIG. 5, since the SWP and OCP comparators become active immediately after the t_{leb} window has ended, there is a likelihood that the OCP protection will still trigger before the SWP protection, despite the time delay.

In particular, and referring to FIG. 5, after the t_{leb} window has ended, the voltage on the sense resistor is fed directly to the SWP comparator, whilst the input to the OCP comparator is delayed by means of an RC-network. This delay is conventionally used to provide the SWP comparator with an opportunity to trigger first. However, in instances of very steep rising current through the switch, due to certain fault conditions such as a shorted transformer winding, as shown in FIG. 5 the large input signal present on the sense resistor and the (necessary) lower OCP reference level (with respect to the SWP reference level) may lead to the OCP protection triggering first (at time tₐ) and thus turning off the power switch. Although the SWP reference level is subsequently exceeded, and, theoretically, this would be detected by SWP comparator at a later time (t_{b}), since the switch has already been turned off by the OCP protection, the SWP protection will not be triggered at time t_{b}. However, since the OCP protection is a non-latched protection, the switch will be turned on again in the next switching cycle, and the cycle will repeat. Consequently, the switch will be stressed in every switching period.

One solution to this problem is to increase the time constant of the RC-network, which delays the input to the OCP comparator. However, an increase in the time constant leads to problems with the normal operation of the OCP circuit. In particular, and referring to FIG. 6, the OCP comparator should measure the voltage on the sense resistor. In FIG. 6, at t=800 ns, the actual input equals 0.4 volts. However, using a delay of 200 ns leads to a delayed input signal of only 0.3 volts to the OCP comparator input. Thus, using large delay values may lead to inaccuracies in the measurement of the actual voltage on the sense resistor.

The present invention aims to provide an alternative technique which addresses the problems associated with conventional current protection of power switches.

In accordance with a first aspect, the present invention provides a method for operating protection circuitry for a power switch, the method comprising: in response to turning on the power switch, starting a first timing window and a second timing window, wherein the second timing window is greater than the first timing window; during the first timing window, preventing operation of first protection circuitry; during the second timing window preventing operation of second protection circuitry; at the end of the first timing window but before the end of the second timing window, allowing operation of the first protection circuitry, and at the end of the second timing window, allowing operation of the second protection circuitry.

By providing two different time windows for the OCP and SWP protection, it is possible to ensure that the latched SWP protection triggers when a fault condition arises in preference to the non-latched OCP protection. This, in turn, ensures that the power switch is not repetitively stressed, since latched protection is preferentially triggered.

Advantageously, using the new methodology, it is possible to protect new types of power switches, such as Lateral Insulated Gate Bipolar Transistors (LIGBTs), which may be more sensitive to high current, against fault conditions such as a shorted transformer winding.

Preferably the first protection circuitry provides protection against fault conditions, and the second protection circuitry provides protection against temporary electrical conditions. For example, the first protection circuitry may provide shorted winding protection or other latched protection and the second protection circuitry may provide over current protection or other non-latched protection.

In one embodiment, the method further includes preventing operation of the first protection circuitry whilst allowing operation of the second protection circuitry. This makes it possible for the same reference levels to be defined for triggering the first and second protection circuitry, whilst ensuring that the second protection circuitry triggers in preference to the first protection circuitry after the end of the second timing window.

In accordance with a second aspect, the present invention provides apparatus for protecting a power switch comprising: sense resistor connected to the source of the power switch; and first power protection circuitry and second power protection circuitry for detecting the voltage level across the sense resistor and triggering if the voltage exceeds a respective first or second reference level, the apparatus further comprising: circuitry for starting a first timing window and a second timing window in response to the power switch being turned on, wherein the second timing window is greater than the first timing window; circuitry for preventing operation of first protection circuitry during the first timing window; circuitry for preventing operation of second protection circuitry during the second timing window; circuitry for allowing operation of the first protection circuitry at the end of the first timing window but before the end of the second timing window, and circuitry for allowing operation of the second protection circuitry at the end of the second timing window.

Other preferred and optional features and advantages of the present invention will be apparent from the following detailed description and accompanying claims.

Embodiments of the present invention will now be described, by way of example, with reference to the accompanying drawings in which:

FIG. 1 is a circuit diagram of protection circuitry for protecting a power switch forming part of a flyback converter SMPS in accordance with the prior art;

FIG. 2 is a timing diagram illustrating the timing of the operation of the protection circuitry of FIG. 1;

FIG. 3 is a timing diagram illustrating the change in voltage on the sense resistor of the circuit of FIG. 1 in response to the power switch being turned on;

FIG. 4 is a circuit diagram showing the circuitry of FIG. 1 in a fault condition due to Shorted Transformer Winding;

FIG. 5 is a timing diagram illustrating the change in voltage on sense resistor and OCP and SWP protection signals for the circuit of FIG. 4 in response to the power switch being turned on;

FIG. 6 is a graph showing the effect of increased time constant τ in the RC-network, which delays the input to OCP protection circuitry;

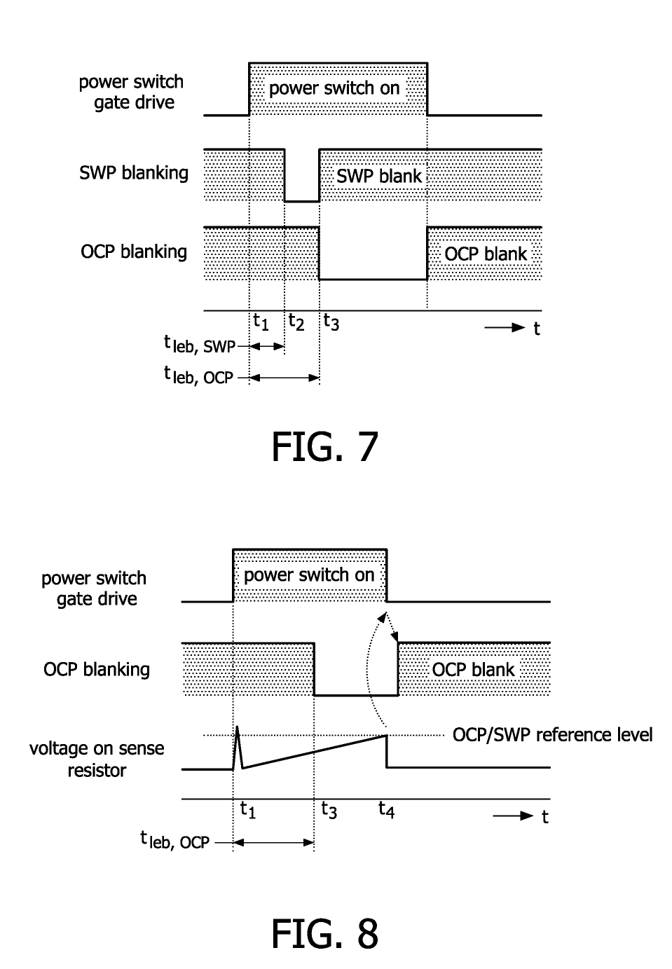

FIG. 7 is a timing diagram illustrating the operation of protection circuitry in accordance with a preferred embodiment of the present invention;

FIG. 8 is a timing diagram illustrating the change in voltage on the sense resistor of a power switch circuit implementing the protection circuitry of the preferred embodiment of the present invention, the voltage triggering OCP protection circuitry;

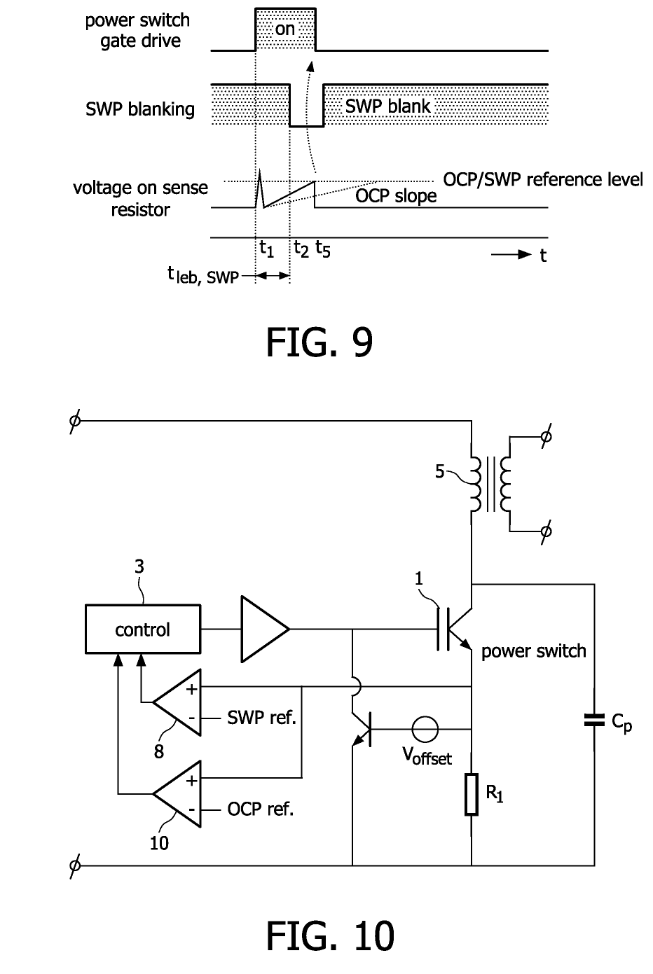

FIG. 9 is a timing diagram of the change in voltage on sense resistor corresponding to that of FIG. 8 but for the voltage triggering SWP protection circuitry;

FIG. 10 is a circuit diagram illustrating the implementation of protection circuitry in accordance with another preferred embodiment of the present invention, in which a LIGBT power switch is used in a flyback converter;

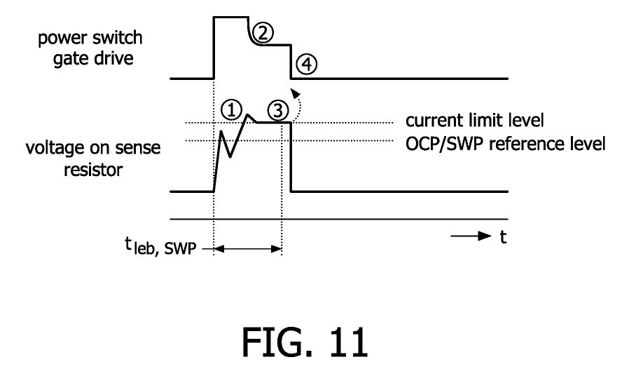

FIG. 11 is a timing diagram illustrating signals associated with the protection circuitry for the LIGBT power switch of FIG. 10;

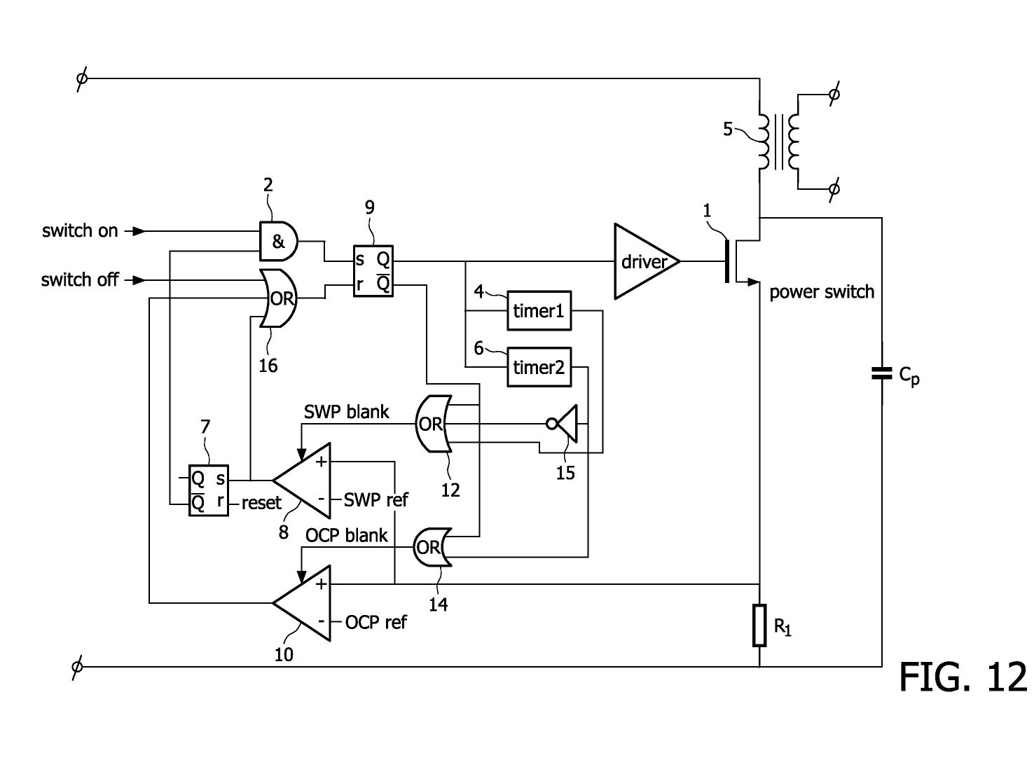

FIG. 12 is an exemplary circuit arrangement for implementing the protection scheme illustrated in FIG. 7, and

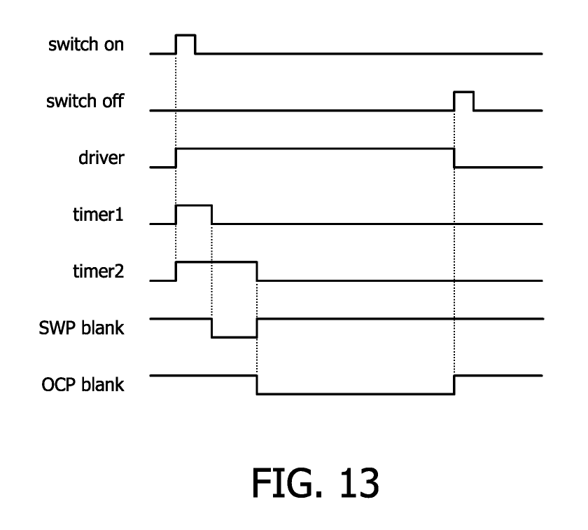

FIG. 13 is a timing diagram of the blanking signals generated by the circuit arrangement of FIG. 12.

In the drawings the same or equivalent features have like reference numerals.

The present invention generally provides a scheme for protecting power switches against current surges by introducing two time windows, one for the OCP or cycle-by-cycle protection which is associated with protecting against a temporary, non-fault condition, and the other for the SWP or latched protection which is associated with protecting against a fault such as a shorted transformer winding.

FIG. 7 illustrates the timing signals for the protection scheme according to one embodiment of the present invention. Directly after the power switch is turned on, both protections are “blanked”, that is prevented from operating, by the generation of blanking signals as described below with reference to FIGS. 12 and 13. This blanking is provided to prevent false triggering due to turn on spikes, as in the prior art. However, in some other embodiments, such as in resonant converters which utilise zero voltage switching, a turn on current peak is not present, so that such a leading edge blanking window is not required.

As illustrated in FIG. 7, after power switch turn on at t₁ a first timing window t_{(leb, SWP)} (for the case of a resonant converter this time might be zero) prevents SWP circuitry from triggering until time t₂. After the first timing window, at time t₂, the SWP protection circuitry can be triggered, whilst the OCP protection circuitry remains “blanked”. A second timing window t_{(leb, OCP)} for the OCP protection circuitry after power switch turn on at time t₁ is accordingly longer than the first timing window. During the second timing window the OCP protection circuitry is “blanked” until time t₃, where t₃>t₂, such that after time t₃, the OCP protection circuitry may be triggered. In the illustrated embodiment, at time t₃ the SWP protection circuitry is again blanked to prevent it from triggering in preference to the OCP protection circuitry. However, in some circumstances mentioned below, this additional blanking of SWP protection circuitry may not be necessary.

The protection scheme in accordance with the present invention is further illustrated by examples with reference to FIGS. 8 and 9.

### EXAMPLE 1

### Triggering of OCP Protection (FIG. 8)

Over current or cycle-by-cycle protection is desirable to prevent high current passing through the power switch due to temporary current surges. In this situation, the voltage on the sense resistor typically ramps up relatively slowly to a high voltage which, conventionally, would cause triggering of OCP protection. As illustrated in FIG. 8, in this situation the voltage on sense resistor ramps up to the OCP reference level for the OCP protection circuitry in accordance with the present invention after time t₃. Since after time t₃ the OCP blanking signal is removed, the OCP protection circuitry triggers at time 4 to switch off the power switch gate drive as illustrated in FIG. 8. Note that during the time period t₂ to t₃, the SWP protection circuitry does not trigger, since the voltage on the sense resistor is below the SWP reference level. Since the OCP protection turns off the power switch with non-latched protection, the power switch is turned back on at the start of the next switching cycle.

As the skilled person will appreciate, this scheme can be used to control the primary peak current in the transformer, and thus the energy transferred to the secondary side of the transformer 5 and the output voltage. In particular, since the current flowing through the primary winding of the transformer 5 also flows through the power switch 1, the selection of the OCP reference level may correspond to the desired primary peak current level of the transformer. In this case, when the peak current level is reached, the power switch/transformer will be turned off by the OCP protection circuitry 10. Accordingly, the OCP reference level need not be a fixed value but could be defined as a value equivalent to the primary peak current for the switching cycle in order to control output voltage.

### EXAMPLE 2

### Triggering of SWP Protection (FIG. 9)

SWP or latched protection is desirable to prevent high current passing through the power switch due to current surges caused by a fault that is present in the power converter arrangement. In a fault situation, the voltage on the sense resistor typically ramps up quickly, as shown in FIG. 9. Thus, the voltage on sense resistor reaches the SWP reference level at time t₅, where t₂<t₅<t₃. Thus, SWP protection circuitry is triggered to turn off the power switch gate drive as illustrated in FIG. 9. Note that since the power switch is turned off before time t₃, when OCP blanking is removed, the OCP protection circuitry is prevented from triggering. Thus, the SWP latched protection occurs, such that the power switch can only be turned on again by reset of the control circuit.

As illustrated in the above Examples, through the use of two separate timing windows for OCP protection and SWP protection circuitry, it is not necessary to define different voltage reference levels for the OCP and SWP comparators. Thus, in the examples illustrated in FIGS. 8 and 9, the OCP and SWP reference levels are the same. In other embodiments, the OCP and SWP reference levels may differ.

It should be noted that if the same reference levels are used for OCP and SWP, then, as in the preferred embodiment described above, it is important that the SWP protection circuitry is prevented from operating after the end of the second timing window, so that the OCP (non-latched) protection will be triggered in the case of a temporary high current condition. However, if the reference levels are different, then blanking of the SWP protection circuitry after the end of the second timing window is not always essential. For example, if the SWP reference level is greater than the OCP reference level, the SWP protection need not be blanked after the end of the second timing window, since the OCP protection circuitry will trigger first. In the case of a fault at this stage, i.e. an SWP situation, although the OCP protection turns off the power switch prior to reaction of the SWP protection, in the next switching cycle the SWP protection will turn off the power switch off and keep it off, since SWP provides latched protection. On the other hand, if the SWP reference level is less than or equal to the OCP reference level, the operation of the SWP protection circuitry needs to be prevented after the second timing window ends. Otherwise it is possible that the SWP protection may be triggered instead of the OCP protection, leading to the aforementioned problems associated with the prior art.

The method of the present invention is advantageously utilised in a LIGBT power switch flyback converter, such as that illustrated in FIG. 10. As is well known in the art, a LIGBT has a much higher current density compared with a MOSFET. In fault conditions, with large current values, a LIGBT is more susceptible to stress. Furthermore, there is a risk that the bipolar LIGBT may enter the latch up state. Thus, the use of an integrated MOSFET is conventionally preferred, since an integrated LIGBT is less robust. However, LIGBTs have the advantage of occupying less die area. Accordingly, it will be appreciated that through the use of the methodology of the present invention, it is possible to utilise an integrated LIGBT and to thereby benefit from the reduced die area required.

FIG. 10 illustrates the implementation of protection circuitry in a flyback converter utilising a LIGBT power switch in accordance with an embodiment of the present invention. The circuit comprises LIGBT power switch 1, the gate of which is driven by Control block 3. Sense resistor R₁, is connected to the emitter of LIGBT 1 and the primary winding of transformer 5 is connected to the collector of LIGBT 1. SWP protection circuitry comprising SWP comparator 8 and OCP protection circuitry comprising OCP comparator 10 each detect the voltage across sense resistor 1 and trigger if the respective SWP/OCP reference level is exceeded. When the SWP or OCP protection circuitry triggers, the comparator sends a corresponding signal to Control block 3 which turns off the LIGBT 1. This is similar to the conventional arrangement as shown in FIG. 1.

In addition, and in contrast to the conventional arrangement, the circuit of the embodiment of FIG. 10 further includes a local feedback circuit. The function of the feedback stage is that it limits the maximum current which can flow through the LIGBT power switch (“current limit level” in FIG. 11, described below). When the voltage on the sense resistor R₁ becomes too high (due to the too high current through the power switch 1), the feedback circuit reduces the gate drive of the power switch 1. Thus, the output of the driver stage is overruled by the feedback mechanism. In this way, a fast response to high current, and consequently quicker current limitation is achieved, thereby preventing the current through the LIGBT rising to very high levels which might otherwise destroy the LIGBT. As will be appreciated from the description of FIG. 11 below, when the current limitation level is above the SWP (fault) reference level, SWP will still be detected at the end of timing window t_{(leb, SWP)} and the power switch will be turned off. Because the SWP is a latched protection the power switch will be kept off. Thus, the protection scheme in accordance with the present invention provides reliable protection for the less robust LIGBT against sudden high currents arising from fault conditions.

The level at which the current limitation becomes active (influenced by V_{offset} in FIG. 10) does not have to be a constant voltage level. The level can be made dependant upon other SMPS parameters, such as the actual level of the input voltage, thus providing increased flexibility.

FIG. 11 shows a timing diagram of current signal levels arising in the circuit of FIG. 10. FIG. 11 shows the following changes:

1: current exceeds ‘current limit level’.

2: gate drive of power switch is reduced to limit the current through the power switch.

3: SWP blanking ends and SWP is detected because the current is already above the SWP level.

4: power switch is turned off as a result of the detected SWP situation.

Due to the limitation of the current through the power switch 1, the voltage on the power switch 1 will start to increase. This is caused by the fact that the voltage drop on the inductive load becomes zero when the dl/dt becomes zero. A momentary high power level is dissipated in the power switch, but this is only for a very small time window; namely during the window t_{(leb SWP)}+turn off delay. It is essential that the duration of this time window is limited, because this limits the dissipated energy in the LIGBT. In a practical solution the time for t_{(leb, SWP)} will be around 225 ns. Adding another 100 ns delay for the comparator to react, this means that the LIGBT can be turned off in 325 ns. Experimental results showed already that the used LIGBT power switch does survive those dissipation peaks (tested up to 800 ns pulse width).

Accordingly, the current limiting illustrated in FIG. 11 limits the current through the LIGBT, thereby preventing stress and potential latching up. The current limiting typically lasts for a duration of several 100 ns because of the momentary high power level during that situation. In the event of a permanent fault condition, the new protection scheme ensures that in the event of an SWP situation, the LIGBT is turned off due to triggering of the SWP protection and not the OCP protection. Since the SWP protection is a latch protection, the LIGBT will not be turned on again, and will survive the fault condition.

FIG. 12 illustrates an exemplary circuit arrangement for implementing the protection scheme of the embodiment of FIG. 7, and in particular for creating the timing windows for the operation of the current protection circuitry. The skilled person will appreciate that other circuit implementations are possible.

The circuit comprises an AND gate 2 the inputs of which are connected to the “switch on” power converter input and a first latch 7 and the output of which can set a second latch 9. Second latch 9 can only be set if first latch 7 is not set and if the input signal (“switch on”) is logic high. The first (Q) output of the second latch 9 drives the driver stage, which in turn drives the gate of the power switch 1. In addition, the first output of second latch 9 is also connected to trigger first and second timer circuits 4, 6. The first and second timers 4, 6 are one-shot circuits; the output of each one-shot circuit stays logic high for a predetermined time period after the input has become logic high. The first and second timers have a different one-shot time. Referring to FIGS. 7 and 12, the first timer circuit 4 controls the SWP protection circuitry and has a first predetermined time period corresponding to the timing window t_{(leb SWP)}, and the second timer circuit 6 controls the OCP protection circuitry and has a second predetermined time period corresponding to t_{(leb OCP)}. Thus, first timer 4 determines when the SWP blanking stops (time t₂), and timer 6 determines when the SWP blanking starts again and the OCP blanking stops (time t₃).

The SWP blanking signal is generated by combining the output signals of both the first and second timers 4, 6 in a first OR gate 12. This first OR gate 12 is fed with signals from the second output of second latch 9, the output of the first timer 4 and the inverted output of second timer 6, provided by inverter 15. The SWP blanking signal is fed to the SWP comparator 8. This combination of logic signals creates the desired SWP blanking window.

The OCP blanking signal is generated by combining the output of first timer 6 and the second latch 9 in a second OR gate 14. The OCP blanking signal is fed to the OCP comparator 10. This ensures that the OCP blanking stops once the one-shot time of second timer 6 has ended under the condition that the switch was turned on.

In the event that the OCP comparator 10 is triggered, its output resets the second latch 9 via third OR gate 16. The power switch 1 is thereby turned off via the driver.

In the event that the SWP comparator 8 is triggered, its output similarly resets the second latch 9 via third OR gate 16, and again the power switch 1 will be turned off via the driver. The output of SWP comparator 8 also sets first latch 7. First latch 7 prevents the switch from being be turned on again in the next switching cycle by disabling the input signal to the AND gate 2. First latch 7 can only be reset by a reset signal. In this way the SWP protection is provided as a latched protection.

As shown in FIG. 13, when the power switch 1 is turned on, the first and second timers 4, 6 start and provide blanking signals via respective OR gates 12, 14 to the SWP/OCP protection circuitry 8, 10 to prevent triggering thereof. Upon expiry of first timer 4, the blanking signal to the SWP comparator 8 is stopped, and the SWP protection circuitry is able to trigger. Upon expiry of second timer 6, the OCP blanking signal to the OCP comparator 10 is stopped, whilst the blanking signal to the SWP comparator 8 is concurrently resumed, thereby enabling on the OCP protection circuitry to trigger.

As the skilled person will appreciate, many variations and modifications may be made to the described embodiments. Such variations and modifications may involve equivalent and other features which are already known in the art, and which may be used instead of, or in addition to, features already described herein.

For example, whilst the illustrated example uses a LIGBT power switch, the protection methodology can be implemented with any form of power switch, including MOSFET switches. The advantage of better discrimination between OCP and SWP protection arises with all forms of power switch. Moreover, whilst the illustrated SMPS is a flyback converter, the protection methodology may be used with all forms of power converters including buck, forward, and resonant converters, where a current level is measured and needs to be protected. In addition, the number of blanking windows is not limited to two. Multiple blanking windows may be used, utilising the same or different comparator levels, to suit the application.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The applicant hereby gives notice that new claims may be formulated to such features and/or combinations of such features during the prosecution of the present application or of any further application derived therefrom.

Accordingly, the present invention is not limited to the described embodiments, but is defined by the accompanying claims.

1. A method for operating protection circuitry for a power switch, the method comprising:
in response to turning on the power switch, starting a first timing window and a second timing window, wherein the second timing window is greater than the first timing window;
during the first timing window, preventing operation of first protection circuitry;
during the second timing window preventing operation of second protection circuitry;
at the end of the first timing window but before the end of the second timing window, allowing operation of the first protection circuitry, and
at the end of the second timing window, allowing operation of the second protection circuitry.

2. A method as claimed in claim 1, wherein the first protection circuitry comprises fault protection circuitry which turns off the power switch in response to detecting a first predefined reference level.

3. A method as claimed in claim 2, wherein the fault protection circuitry provides latched protection so that the power switch may not be turned on again without reset.

4. A method as claimed in claim 2, wherein the step of allowing operation of the first protection circuitry comprises providing a signal corresponding to a voltage across a sense resistor to a comparator of the first protection circuitry, the comparator comparing the voltage signal with the first reference level.

5. A method as claimed in claim 4, wherein if the comparator of the first protection circuitry determines that the voltage signal is greater than or equal to the first reference level the first protection circuitry turns off the power switch.

6. A method as claimed in claim 5 wherein, if the first protection circuitry turns the power switch off, the method further comprises: in response to a reset signal, turning the power switch back on.

7. A method as claimed in claim 4 wherein the step of preventing operation of the first protection circuitry comprises providing a blanking signal to the comparator of the first protection circuitry.

8. A method as claimed in claim 2, wherein the second protection circuitry comprises over current protection circuitry which turns off the power switch in response to detecting a second predefined reference level.

9. A method as claimed in claim 8, wherein the over current protection circuitry provides non-latched protection.

10. A method as claimed in claim 8, wherein the step of allowing operation of the second protection circuitry comprises providing a signal corresponding to a voltage across a sense resistor to a comparator of the second protection circuitry, the comparator comparing the voltage signal with a second reference level.

11. A method as claimed in claim 10, wherein if the comparator of the second protection circuitry determines that the voltage signal is greater than or equal to the second reference level the second protection circuitry turns off the power switch.

12. A method as claimed in claim 11, wherein, if the second protection circuitry turns the power switch off, the method further comprises: upon the start of a next switching cycle, turning the power switch back on.

13. A method as claimed in claim 10, wherein the step of preventing operation of the second protection circuitry comprises providing a blanking signal to the comparator of the second protection circuitry.

14. A method as claimed in claim 1, wherein concurrently with allowing operation of the second protection circuitry, the method comprises preventing operation of the first protection circuitry.

15. A method as claimed in claim 14, wherein the first reference level is less than or equal to the second reference level.

16. A method as claimed in claim 1, wherein the second reference level is used to control a primary current peak through a transformer of the power switch.

17. A method as claimed in claim 1, wherein the power switch is a LIGBT.

18. Apparatus for protecting a power switch comprising:
sense resistor connected to the source of the power switch; and first power protection circuitry and second power protection circuitry for detecting the voltage level across the sense resistor and triggering if the voltage exceeds a respective first or second reference level, the apparatus further comprising:
circuitry for starting a first timing window and a second timing window in response to the power switch being turned on, wherein the second timing window is greater than the first timing window;
circuitry for preventing operation of first protection circuitry during the first timing window;
circuitry for preventing operation of second protection circuitry during the second timing window;
circuitry for allowing operation of the first protection circuitry at the end of the first timing window but before the end of the second timing window, and
circuitry for allowing operation of the second protection circuitry at the end of the second timing window.

19. Apparatus as claimed in claim 18, further comprising a feedback stage for limiting the current through the power switch.
